(19) United States
(12) Patent Application Publication
(10) Pub. No.: US 2011/0029505 A1
(43) Pub. Date: Feb. 3, 2011

(54) METHOD AND SYSTEM FOR CHARACTERIZING WEB CONTENT

(76) Inventors: Martin B. Scholz, San Francisco, CA (US); Shyam Sundar Rajaram, Mountain View, CA (US); Rajan Lukose, Oakland, CA (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/533,717

(22) Filed: Jul. 31, 2009

(51) Int. Cl. G06F 17/30

(52) U.S. Cl. 707/711; 707/E17.039

(57) ABSTRACT

An exemplary embodiment of the present invention provides a method of processing Web activity data. The method includes obtaining a database of clickstream data comprising a user identifier corresponding with a user ID and a uniform resource locator (URL) corresponding with a Web page visited from the user ID. The method also includes generating a plurality of features based on the URL. Further, the method includes generating a data structure comprising the user ID and the feature. The method also includes generating segment information from the data structure based on the similarity of a URL visitation pattern across different user IDs, wherein each segment in the segment information comprises one or more user IDs and one or more features.

### BACKGROUND

Marketing on the World Wide Web (the Web) is a significant business. Users often purchase products through a company's Website. Further, advertising revenue can be generated in the form of payments to the host or owner of a Website when a user selects an advertisement that appears on the Website. The amount of revenue earned through Website advertising and product sales may depend on the Website's ability to provide marketing material or other Web content that is targeted to specific users, based on the user's interests.

### BRIEF DESCRIPTION OF THE DRAWINGS

Certain exemplary embodiments are described in the following detailed description and in reference to the drawings, in which:

FIG. 1 is a block diagram of a computer network in which a client system can access a search engine and Websites over the Internet, in accordance with exemplary embodiments of the present invention

FIG. 2 is a process flow diagram of a method of generating a segmentation of Web content, in accordance with exemplary embodiments of the present invention;

FIG. 3 is a graphical representation of an exemplary user ID/feature matrix that may be used to generate the segment information; and

FIG. 4 is a block diagram showing a tangible, machine-readable medium that stores code adapted to generate a segmentation of Web content, in accordance with exemplary embodiments of the present invention.

### DETAILED DESCRIPTION OF SPECIFIC EMBODIMENTS

Exemplary embodiments of the present invention provide techniques for generating a segmentation of Web content. As used herein, the term “exemplary” merely denotes an example that may be useful for clarification of the present invention. The examples are not intended to limit the scope, as other techniques may be used while remaining within the scope of the present claims. These techniques can provide methods for characterizing a particular user identification (user ID) in terms of the Web content accessed from that user ID and characterizing a particular Website in terms of the Web content provided. The segmentation results may be used to target Web content to specific user IDs.

In exemplary embodiments of the present invention, a segmentation of user IDs and Web content is generated and used to identify user IDs that have similar interests. The segmentation information may be useful for providing targeted Web content to a user ID. For example, a user of a user ID that regularly accesses a business page on a first Website may be interested in a similar business page on a second Website, even though the user may never have accessed the page on the second Website. If numerous other user IDs that have been used to access both Websites, the user IDs may placed in a segment with the similar business pages on both the first and the second Websites. The segment information may then be used to provide a suggestion to the user to access the business page on the second Website. In other exemplary embodiments, the segment information may be used to provide specific advertising to a certain user ID.

The segments may be generated by statistically processing a database of Web activity (such as clickstream data), for example, by information-theoretic co-clustering or other machine learning techniques based on statistical or stochastic processes. As used herein, a “database” is an integrated collection of logically related data that consolidates information previously stored in separate locations into a common pool of records that provide data for an application.

In an exemplary embodiment, the clickstream data for a plurality of user IDs may be processed to generate segments that correlate user IDs with Website accesses. Furthermore, prior to segmenting the clickstream data, the clickstream data may be processed to automatically determine a level of abstraction for uniform resource locators (URLs) that provides a more useful grouping of user IDs and Web pages. It should be clear that the present invention is not limited to the analysis of URLs (i.e., hyper-text transfer protocol sites). In other embodiments, information accessed under any number of other protocols (such as file transfer protocol (FTP), user datagram protocol (UDP), and the like) may be analyzed and used to provide targeted web content. These protocols may be formatted using a uniform resource identifier (URI) such as a URL.

The pre-segmentation processing of the clickstream data may include generating a plurality of features corresponding to each uniform resource locator (URL) in the clickstream data and filtering out the features that are not sufficiently supported. The resulting segment information provides groupings of Web pages and groupings of user IDs that have tended to visit those Web pages. The groupings, referred to herein as “segments,” may be used to provide users with Web content that is targeted to a particular user's interests.

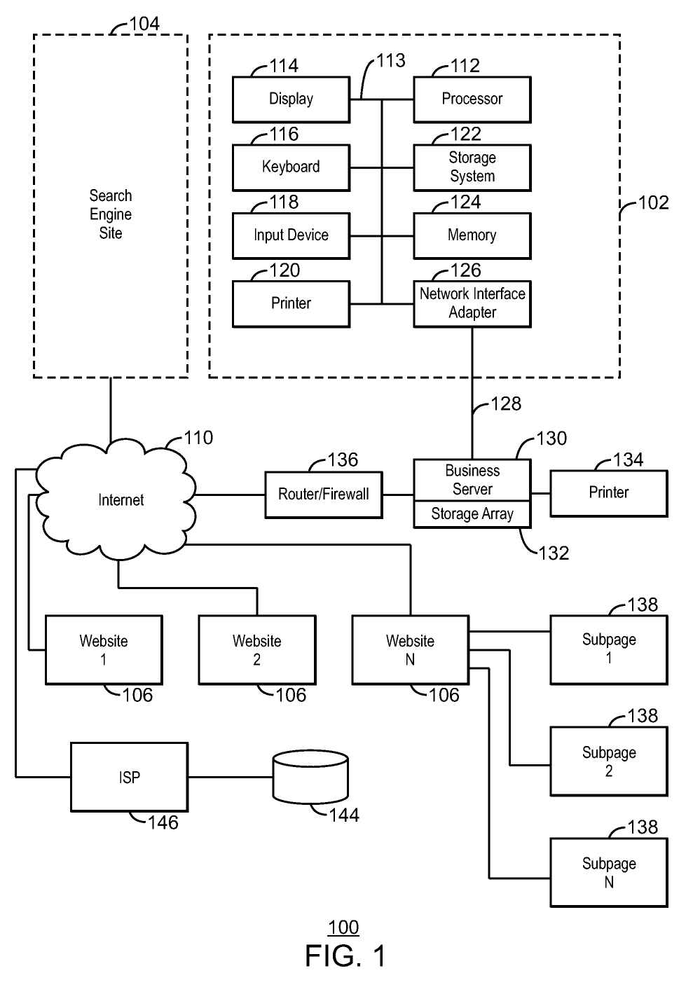

FIG. 1 is a block diagram of a computer network 100 in which a client system 102 can access a search engine 104 and Websites 106 over the Internet 110, in accordance with exemplary embodiments of the present invention. As illustrated in FIG. 1, the client system 102 will generally have a processor 112 which may be connected through a bus 113 to a display 114, a keyboard 116, and one or more input devices 118, such as a mouse or touch screen. The client system 102 can also have an output device, such as a printer 120 connected to the bus 113.

The client system 102 can have other units operatively coupled to the processor 112 through the bus 113. These units can include tangible, machine-readable storage media, such as a storage system 122 for the long term storage of operating programs and data, including the programs and data used in exemplary embodiments of the present techniques. The storage system 122 may also store a user profile generated in accordance with exemplary embodiments of the present techniques. Further, the client system 102 can have one or more other types of tangible, machine-readable media, such as a memory 124, for example, which may comprise read-only memory (ROM), random access memory (RAM), or hard drives in a storage system 122. In exemplary embodiments, the client system 102 will generally include a network interface adapter 126, for connecting the client system 102 to a network, such as a local area network (LAN 128), a wide-area network (WAN), or another network configuration. The LAN 128 can include routers, switches, modems, or any other kind of interface device used for interconnection.

Through the LAN 128, the client system 102 can connect to a business server 130. The business server 130 can also have machine-readable media, such as storage array 132, for storing enterprise data, buffering communications, and storing operating programs for the business server 130. The business server 130 can have associated printers 134, scanners, copiers and the like. The business server 130 can access the Internet 110 through a connected router/firewall 136, providing the client system 102 with Internet access. The business network discussed above should not be considered limiting, as any number of other configurations may be used. Any system that allows a client system 102 to access the Internet 110 should be considered to be within the scope of the present techniques.

Through the router/firewall 136, the client system 102 can access a search engine 104 connected to the Internet 110. In exemplary embodiments of the present invention, the search engine 104 can include generic search engines, such as GOOGLE™, YAHOO®, BING™, and the like. The client system 102 can also access the Websites 106 through the Internet 110. The Websites 106 can have single Web pages, or can have multiple subpages 138. Although the Websites 106 are actually virtual constructs that are hosted by Web servers, they are described herein as individual (physical) entities, as multiple Websites 106 may be hosted by a single Web server and each Website 106 may collect or provide information about particular user IDs. Further, each Website 106 will generally have a separate identification, such as a URL, and function as an individual entity.

The Websites 106 can also provide search functions, for example, searching subpages 138 to locate products or publications provided by the Website 106. For example, the Websites 106 may include sites such as EBAY®, AMAZON.COM®, WIKIPEDIA™, CRAIGSLIST™, FOXNEWS.COM™, and the like. In exemplary embodiments of the present invention, one or more of the Websites 106 may be configured to collect information about a visitor, such as using the visitor's user ID to access segment information. The Website 106 may use the segment information to determine targeted content to deliver to the user ID.

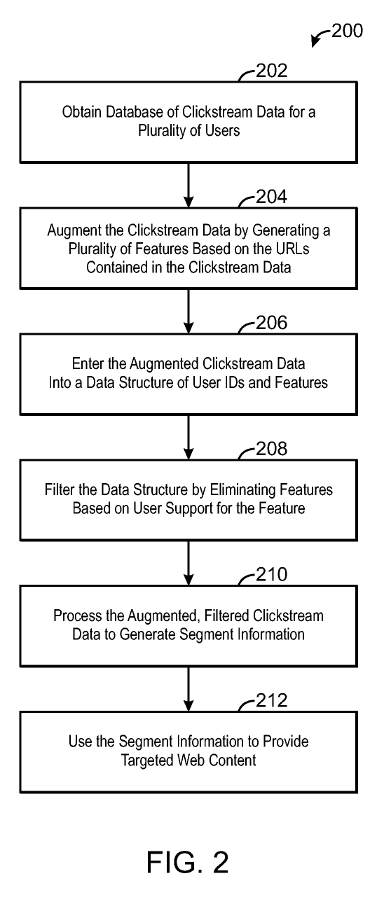

The client system 102 and Websites 106 may also access a database 144, which may be connected to an Internet service provider (ISP) 146 on the Internet 110. The database 144 may be accessible to the client system 102 and one or more of the Websites 106 and may store clickstream data, as described below in reference to FIG. 2. Further, the database 144 may include segment information generated by an automated statistical analysis of the clickstream data. However, the segment information does not have to be stored in the database 144, as it may be generated and stored in the client system 102, the business server 130, a search engine 104, or in a Website 106.

The segment information may determine groups of users that tend to visit the same Web pages and groups of Web pages that tend to be visited by the same users. The segment information, therefore, enables users and Web pages to be grouped according to similar visitation patterns. The segmentation of Web content may then be used by the Websites 106 to determine the content of a Web page based on the visitation patterns of the user. For example, the segment information may be used to deliver targeted Web page advertising.

FIG. 2 is a method of generating a segmentation of Web content, in accordance with exemplary embodiments of the present invention. Different combinations of the units referred to in FIG. 1 may be used to implement the method. For example, in one exemplary embodiment, blocks 204-212, as described below, may be implemented by a client system 102 that is identified with a particular user ID. In this embodiment, the clickstream data may be collected by an ISP 146, a search engine 104, a business server 130, and the like, and retrieved for analysis by the client system 102. In other embodiments, the actions discussed with respect to block 212 may be performed by a Website 106 (such as a content or advertising provider) or a search engine 104. One of ordinary skill in the art will recognize that the configurations above are not limiting, as any combination of the devices described with respect to FIG. 1 may be used to implement the various steps of the method.

The method is generally referred to by the reference number 200 and may begin at block 202, wherein a database of clickstream for a plurality of user IDs is obtained. The clickstream data may include a recording of the Web browsing activity from a large number of user IDs. For example, the clickstream data may include user IDs in the form of encoded IP addresses that correspond to individual client systems 102 (FIG. 1) and a list of URLs corresponding to the Web pages visited from each user ID. The clickstream data may also include additional information such as the time and date that the Web page was visited, the length of time spent at the site, and the like. Further, the clickstream data may include information about the content of the Web pages, for example, the Web page title, tags, and the like.

The URLs contained in the clickstream data may include various levels of abstraction. A URL with a high level of abstraction is one that may represent a broad range of subject matter, for example, a domain name of a Website such as “http:/www.google.com.” A URL with a low level of abstraction is one that may represent very specific subject matter, for example, a specific article or publication such as “http://www.google.com/support/websearch/bin/answer=136861.” It will be appreciated that URLs with a low level of abstraction may represent specific Web content that may not be accessed from a large number of user IDs. Therefore, URLs that are too abstract may not be visited from enough user IDs to provide data for a meaningful statistical analysis. For example, if a Website 106 is visited from less than about 20 user IDs, the sample set may not be large enough to be statistically significant.

On the other hand, a URL that is very general may be visited from large numbers of user IDs representing users with very divergent sets of interests. For example, AMAZON.COM™ and CNN.COM™ are likely to both have been accessed from any one user ID. Thus, URLs at the highest level of abstraction, which may have been accessed from most (for example, greater than about 50%) user IDs, may not provide useful information regarding specific interests of groups of individuals. Therefore, URLs that are too abstract or too specific may not yield useful results during the segmentation of Web content, as described below. To avoid this problem, the highly abstract URLs may be reduced to a lower level of abstraction. Exemplary embodiments of the present invention provide techniques for automatically determining the level of URL abstraction that provides a useful and accurate segmentation of Web content, as described below.

At block 204, the clickstream data may be augmented by generating a plurality of features from the URLs contained in the clickstream data. In some exemplary embodiments, the features may be generated by truncating the URL. For example, the URL may be successively truncated at each forward slash to provide several URL features of increasing abstraction. For example, the URL “blog.wired.com/business/2008/10/googles-mail-go.htm” may be used to generate such features as “blog.wired.com/business/2008/10,” “blog.wired.com/business/2008,” “blog.wired.com/business,” and “blog.wired.com.” Additional features may be generated by truncating the domain name at each dot. For example, “blog.wired.com” may be used to generate the additional features “wired.com,” “com.”

Features may also be generated from the URLs of search engines. For example, keywords pertaining to the subject matter of the search may be extracted from the search engine URL and each keyword may be a new feature. In other embodiments, additional features may also be generated from the content of Web pages. For example, if the title of a Web page is available, each word in the title may be a new feature. In some exemplary embodiments, the Web page content may be available in the clickstream data. In other embodiments, the Web page content may be obtained by accessing the Web page and extracting the Web content directly from the Web page. Each of the features may be associated with the same user ID as the original URL from which the feature was generated.

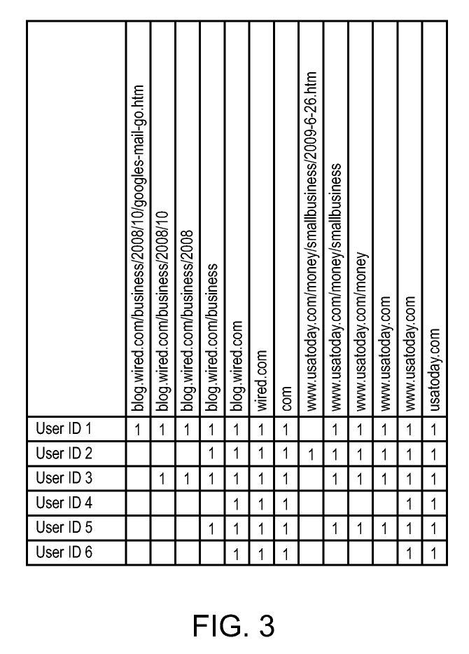

At block 206, the augmented clickstream data may be entered into a data structure, such as a matrix, of user IDs and features to prepare the data for the segmentation processing. An exemplary segmentation technique may be better understood with reference to FIG. 3. FIG. 3 is a graphical representation of an exemplary user ID/feature matrix that may be used to generate the segment information. To assist in explanation, this representation is simpler than may be present in real world data. As shown in FIG. 3, the user IDs from the clickstream data may be distributed along rows, and the features generated at block 204 of FIG. 2 may be distributed along columns. For each user ID-feature pair in the clickstream data, the matrix entry at the intersection of the user ID and feature may be set to one. For example, if a particular user ID has been used to access a site corresponding with the feature, the matrix entry at the intersection of the user ID and the feature will be set to one. All other matrix entries may be empty or set to zero.

Returning to FIG. 2, at block 208, the data structure may be filtered by eliminating features based on the level of support for the feature. For example, the level of support for a feature refers to the number of users that have visited the Web page corresponding with the feature. If a feature has a low level of support, the Web page corresponding with the feature has been visited by few users. If a particular feature has not been accessed from a large enough number of user IDs, the segmentation of Web content may not yield statistically significant data with respect to that feature. Thus, if a particular column of the matrix contains a low number of entries, which indicates that few of the users have visited the Web page corresponding with that feature, the column for that feature may be eliminated. Accordingly, a number ‘N’ (such as 20, 40, 60, 100, or larger) may be specified such that any column with fewer than N entries may be eliminated. For example, with reference to FIG. 3, it can be seen that the feature “blog.wired.com/business/2008/10/googles-mail-go.htm” is supported by only one user ID in the matrix, indicating that only one user has visited the Web page corresponding with the feature. Therefore, the column for this feature may be eliminated.

Similarly, if a particular column of the matrix contains a high number of entries, indicating that a large number of the users have visited the Web page corresponding with the feature, then the column for that feature may also be eliminated. More specifically, if a particular feature has been visited by too many users, the segmentation of Web content may not yield statistically significant data with respect to that feature, i.e., user IDs may not be able to be distinguished by that feature. Accordingly, a number ‘M’ (such as 100000, 10000, 1000, or smaller) may be specified such that any column with more than M entries may be eliminated. For example, with reference to FIG. 3, it can be seen that the feature “com” has been accessed from all user IDs. Therefore, the “com” feature column may be eliminated. The processes of feature generation (block 204) and feature filtering (block 208) enable the method 200 to automatically determine the level of URL abstraction that may provide a useful and accurate segmentation of Web content.

At block 210, the segment information is generated from the augmented and filtered clickstream data by segmenting the user IDs and the features into several groups based on the distribution of matrix entries. The user IDs may be grouped together based on the similarity of each user IDs distribution of column entries. Further, the features may be grouped together based on the similarity of each feature's distribution of row entries. The resulting segment information may include groupings of user IDs and features, referred herein as “segments,” that may be used to identify groups of user IDs that show similar interests and groups of associated Web pages that provide similar content. The segment information may be generated by an automated analysis of the clickstream data matrix, for example, using a statistical analysis such as clustering, co-clustering, information-theoretic co-clustering, and the like. Other machine learning techniques or stochastical techniques may also be used. An exemplary segmentation technique may be better understood with reference to FIG. 3.

As shown in the exemplary matrix of FIG. 3, the rows corresponding to User ID 1 and User ID 3 have similar distributions of column entries. Thus, User ID 1 and User ID 3 may be grouped into the same segment. Additionally, the columns corresponding to Web pages “blog.wired.com/business,” and “www.usatoday.com/money/smallbusiness” have similar distributions of row entries. Thus, the Web pages “blog.wired.com/business,” and “www.usatoday.com/money/smallbusiness” may also be grouped into the same segment. Table 1 represents an example of segment information that may be obtained after the automated analysis of the exemplary user/feature matrix of FIG. 3.

As shown in table 1, each segment may include a group of user IDs that are similar in terms of the Web pages they have been used to access. Each segment may also include a group of Web pages that are commonly visited from the user IDs included in the segment. For purposed of the present description, Web pages located in the same segment, thus showing similar access visitation patterns, are referred to as “co-located.” The similarity of the visitation patterns of the user IDs included in each segment may be used to target those user IDs as well as other user IDs with Web content that is more likely to be of interest to an individual. It should be clearly recognized that the term “similarity” may generally refer to co-located pages.

In some embodiments, each segment may be associated with a segment identifier, which may be a category name applied by a human analyst. The segment identifier may also be an automatically generated identification code. It can be appreciated from the foregoing example, that the similarity between the user IDs and the Web pages can be ascertained without knowing the meanings of the words contained in the URL or the content of the Web pages. In other words, the process of generating the segment information may not involve human lexical interpretation. Furthermore, it will be appreciated that the process described above may result in a large number of segments, for example, tens, hundreds, or thousands of segments.

TABLE 1
Examples of Web content segments.

| Segment 1 | Segment 2 |
|---|---|
| User ID 1, 2, 3, 5 | User ID 4, 6 |
| blog.wired.com/business | blog.wired.com |
| http://www.usatoday.com/money/smallbusiness | www.usatoday.com |

As previously noted, the graphical representation of the word/Website matrix of FIG. 3 (and summarized in Table 1) is simplified to aid in explaining the invention. In actual practice, the word/Website matrix will generally be more complex, for example, including several thousands of user IDs and features stored in a machine-readable medium for electronic processing. Furthermore, while the user IDs and features are generally aligned in this example, real word data will often have substantially more overlap between user IDs and Websites.

At block 212, the segment information may be used to provide targeted Web content to a user, for example, from a Website 106, a search engine 104, or an advertising server. Furthermore, the segment information may be analyzed by a person, or may be used directly without human analysis, to determine the content of a Web page. In one exemplary embodiment, the segment information may be analyzed by a person to identify patterns in Internet usage, and the results of the human analysis may then be used to tailor the content of specific Web pages or Websites. For example, analysis of the segment information may reveal two or more co-located Web pages, indicating that user IDs that visit one of the co-located Web pages also tend to visit the other co-located Web pages. Therefore, a particular Web page may be adapted to display Web advertising related to the other co-located Web pages. For example, referring to Table 1, the Web page “blog.wired.com/business” may be adapted to provide a Web advertising link to the Web page “http://www.usatoday.com/money/smallbusiness,” and vice-versa.

Additionally, the segment information may be inspected to determine an intuitive category name for each segment based on the apparent subject matter encompassed by each segment. For example, referring to Table 1, Segment 1 may be assigned the category name “business.” The assignment of category names may provide market analysts with more intuitive information about the segments without inspecting the URLs within each segment. Furthermore, the category names may also be used in an automated process for delivering Web content. In other embodiments, the segment information may be automatically assigned an identification code rather than a category name.

In an exemplary embodiment of the present invention, an automated process for generating personalized Web content may include determining content of a Web page based on Web pages that are co-located within the segment information, i.e., represent similar content. Referring also to FIG. 1, the segment information may be made available to a Website 106, for example, via the database 144. In exemplary embodiments of the present invention, the segment information may be generated by a third party and provided to the Websites 106 via the Internet 110 as part of a subscription service, for example. In exemplary embodiments, the clustering information may be stored on the Website 106. In other exemplary embodiments, the segment information may be stored on the database 144 and accessed by the Websites 106 through the Internet 110. Furthermore, the clustering information may be updated periodically, such as weekly, monthly, or yearly, among others. For each Web page 138 administered by a Website 106, the Website may access the segment information to identify a segment that includes the Web page 138. The Website 106 may then identify one or more co-located Web pages 138 from the identified segment. The content of each Web page 138 may then be determined based, in part, on the other co-located Web pages. For example, advertisements and links for the other co-located Web pages may be inserted into the Web page 138.

In another exemplary embodiment of the present invention, an automated process for generating Web content may include targeting a particular user ID accessing a Website based on the segment or segments to which the user ID belongs. Referring also to FIG. 1, a Website 106 may receive a user ID from the client system 102, for example, an IP address. The user ID may be used to search the segment information for one or more segments corresponding to the user ID. If a segment corresponding to the user ID is found, the segment features may be read from the segment, and the content of the Website 106 may be determined based, in part, on the segment features. For example, an advertisement or a link to a Web page corresponding with one of the features may be inserted displayed to the user by the Website 106. In this way, the Website content may be adapted differently for each user ID, depending on the specific interests indicated by a user ID's visitation pattern. In view of the present specification, a person of ordinary skill in the art will recognize various other methods of using the segment information to determine the content of a Website 106.

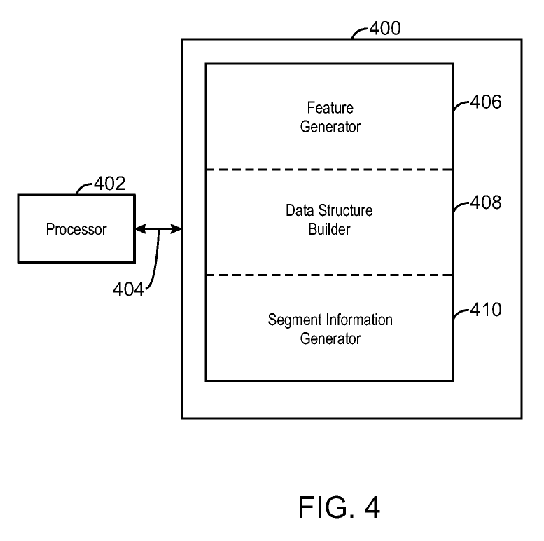

FIG. 4 is a block diagram showing a tangible, machine-readable medium that stores code adapted to facilitate the segmentation of Web content, in accordance with an exemplary embodiment of the present invention. The tangible, machine-readable medium is generally referred to by the reference number 400. The tangible, machine-readable medium 400 can comprise RAM, a hard disk drive, an array of hard disk drives, an optical drive, an array of optical drives, a non-volatile memory, a USB drive, a DVD, a CD, and the like. In one exemplary embodiment of the present invention, the tangible, machine-readable medium 400 can be accessed by a processor 402 over a computer bus 404.

The various software components discussed herein can be stored on the tangible, machine-readable medium 400 as indicated in FIG. 4. For example, a first block 406 on the tangible, machine-readable medium 400 may store a feature generator adapted to receive a URL from a database of clickstream data and generate one or more features based on the URL. In some embodiments, the feature generator may generate the features by successively truncating the URL from the right at each forward slash in the URL. Accordingly, the generated features may represent additional Web pages that may be visited from a user ID. A second block 408 can include a data structure builder that receives a user ID from the clickstream data and a set of features from the feature generator that correspond with the user ID and enters the user ID and features into a data structure, for example, a matrix. The data structure builder may also be adapted to fill the matrix according to whether a user ID accessed the Web page represented by the feature. A third block 410 can include a segment information generator adapted to process the data structure to generate groupings of users and features based on a similarity of a visitation pattern of the user IDs. The tangible, machine-readable medium 400 may also include other software components, for example, a feature eliminator adapted to filter out certain features based on the feature's support in the matrix. The feature eliminator may remove features from the data structure that have a level of support that is too low or too high.

Although shown as contiguous blocks, the software components can be stored in any order or configuration. For example, if the tangible, machine-readable medium 400 is a hard drive, the software components can be stored in non-contiguous, or even overlapping, sectors.

What is claimed is:

1. A method of processing Web activity data, comprising:
retrieving a database of clickstream data comprising a user identifier (user ID) and a uniform resource locator (URL) corresponding to a Web page;
truncating the URL to identify a feature of the URL;
building a data structure comprising the user ID and the feature; and
generating segment information from the data structure based on a similarity of a URL visitation pattern across different user IDs, wherein each segment in the segment information comprises one or more of the different user IDs and one or more features.

2. The method of claim 1, wherein truncating the URL to identify a feature generates lower-level URLs with gradually increasing levels of abstraction compared to the URL.

3. The method of claim 1, wherein truncating the URL to identify a feature comprises truncating the URL at a delimiter including at least one of a slash, ampersand, an at sign, a question mark, a colon, a number sign, or an equals sign.

4. The method of claim 1, wherein truncating the URL to identify a feature comprises extracting keywords from the URL of a search engine.

5. The method of claim 1, comprising eliminating the feature based on a count of the different user IDs that have visited the Web page corresponding to the feature.

6. The method of claim 5, wherein eliminating the feature comprises specifying a count N and eliminating the feature if the Web page corresponding to the feature has been visited by less than N of the different user IDs.

7. The method of claim 1, wherein generating the segment information comprises processing the data structure using at least one of clustering, co-clustering, or information-theoretic co-clustering.

8. The method of claim 1, comprising loading the segment information to a database that is accessible to a Website, wherein the Website uses the segment information to determine the content of a Web page.

9. The method of claim 8, wherein the segment information is used by the Website to provide an advertisement to a user ID that is accessing the Website.

10. The method of claim 1, comprising assigning a category name to each segment in the segment information based on an apparent subject matter encompassed by the segment.

11. A computer system, comprising:
a processor that is adapted to execute machine-readable instructions;
a storage device that is adapted to store data, the data comprising a database of clickstream data; and
a memory device that stores instructions that are executable by the processor, the instructions comprising:
a feature generator adapted to receive a URL from the database of clickstream data and generate one or more features based on the URL;
a data structure builder adapted to analyze the clickstream data to identify a user ID and one or more features that correspond with the user ID and to enter the user ID and the one or more features into a data structure; and
a segment information generator adapted to process the data structure to generate segments that group user IDs and the one or more features based on a similarity of a visitation pattern.

12. The computer system of claim 11, wherein the feature generator truncates the URL at each forward slash in the URL to provide the one or more features.

13. The computer system of claim 11, wherein the feature generator truncates the URL at each dot in a domain name of the URL to provide the one or more features.

14. The computer system of claim 11, wherein the instructions comprise a feature eliminator that is configured to remove features from the data structure that have a level of support that is too high or too low.

15. The computer system of claim 14, wherein the feature eliminator is adapted to remove features from the data structure that are supported by less than a minimum number of visitors.

16. The computer system of claim 11, wherein the segment information generator is adapted to generate the groupings via co-clustering.

17. The computer system of claim 11, wherein each of the segments comprises a list of Web page URLs and a corresponding list of user IDs that have accessed the Web page addresses.

18. A tangible, computer-readable medium, comprising:
code adapted to receive a URL from a database of clickstream data and generate one or more features based on the URL;
code adapted to receive a user ID from the clickstream data and a plurality of features from the feature generator that correspond with the user ID and enter the user ID and features into a data structure; and
code adapted to process the data structure to generate groupings of user IDs and features based on a similarity of a visitation pattern.

19. The tangible, computer-readable medium of claim 18, comprising code adapted to truncate a URL to produce a plurality of features comprising new URLs with increasing levels of abstraction.

20. The tangible, computer-readable medium of claim 18, comprising code adapted eliminate the new URLs from the data structure if the new URLs are not matched with a preselected number of user IDs.
